(19) United States
(12) Patent Application Publication
(10) Pub. No.: US 2012/0257786 A1
(43) Pub. Date: Oct. 11, 2012

(54) CREATING A DETAILED CONTACT RECORD FROM A DIGITAL IMAGE OF A BUSINESS CARD AND ASSOCIATED COMPANY DATA

(75) Inventor: Daniel Scott Camper, Cedar Park, TX (US)

(73) Assignee: THE DUN & BRADSTREET CORPORATION, Short Hills, NJ (US)

(21) Appl. No.: 13/439,896

(22) Filed: Apr. 5, 2012

Related U.S. Application Data
(60) Provisional application No. 61/472,509, filed on Apr. 6, 2011.

(51) Int. Cl. G06K 9/46; G06K 9/18; G10L 15/26; G06K 9/54

(52) U.S. Cl. 382/100; 382/305; 382/182; 704/235; 704/E15.043

(57) ABSTRACT

There is provided a method that includes (a) receiving image data, (b) processing the image data to yield first data, (c) obtaining second data from a repository, based on the first data, and (d) storing the first data and the second data as a record in a database. There is also provided a method that includes (a) receiving image data, (b) processing the image data to yield first data and second data, (c) matching the first data to a record that is stored in a database, and (d) updating the record to include the second data. There is also provided a system that performs the methods, and a storage medium that contains instructions that control a processor to perform the methods.

### BACKGROUND

1. Field of the Disclosure

The present disclosure relates to personal networking and more particularly, to a method and system for electronically creating a unique contact record generated from a digital image retrieved from a business card and associated company data.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Conventional techniques to manage contact data, e.g., a person's name and a company name, require physical storage of files, such as business cards. Access to such files is limited by the physical location of storage.

Techniques that attempt to overcome limitations of physical storage of files include storage of contact data as an electronic file. However, electronic storage of the contact data requires a task of manually entering the contact data. This task is time consuming and is subject to user error, since a user must manually enter information correctly.

In addition, conventional marketing tools, such as business cards, take liberties in presenting contact data. That is, business cards can contain contact data that include a nickname or a “short-name” for a company different from an official company name. For example, a business card may provide a company name as “ABC”, while the official company name is “Always Be Careful”. Thus, contact data and official company name do not match, resulting in erroneous storage of contact data.

Further, a business card provides only a limited amount of contact data due to inherent limitations of physical dimensions. For example, business cards contain contact data such as an address, a telephone number, and a single name of a person. Company data, e.g., a business synopsis, associated with the contact data cannot fit on a conventional business card due to the above-mentioned limitations of physical dimensions. Accordingly, company data is not represented on the business card. Thus, if a recipient of the business card desires company data, the recipient is required to undertake a task of identifying accurate business data based on the contact data.

Further, at present, there are no systems to manage the business data so identified, e.g., obtain and store business data associated with contact data.

There is a need for a system and method that efficiently and accurately obtains and manages company data based on contact data that is obtained from a business card.

### SUMMARY

There is provided a method that includes (a) receiving image data, (b) processing the image data to yield first data, (c) obtaining second data from a repository, based on the first data, and (d) storing the first data and the second data as a record in a database. There is also provided a method that includes (a) receiving image data, (b) processing the image data to yield first data and second data, (c) matching the first data to a record that is stored in a database, and (d) updating the record to include the second data. There is also provided a system that performs the methods, and a storage medium that contains instructions that control a processor to perform the methods.

### BRIEF DESCRIPTION OF THE DRAWINGS

FIG. 1 is a block diagram of a system for electronically managing business contact information.

FIG. 2 is another block diagram of the system of FIG. 1, and includes additional features.

FIG. 3 illustrates additional features of the system of FIG. 1.

FIG. 4 is a flowchart of a method for managing business contact information

FIG. 5 is a flowchart of another method for managing business contact information.

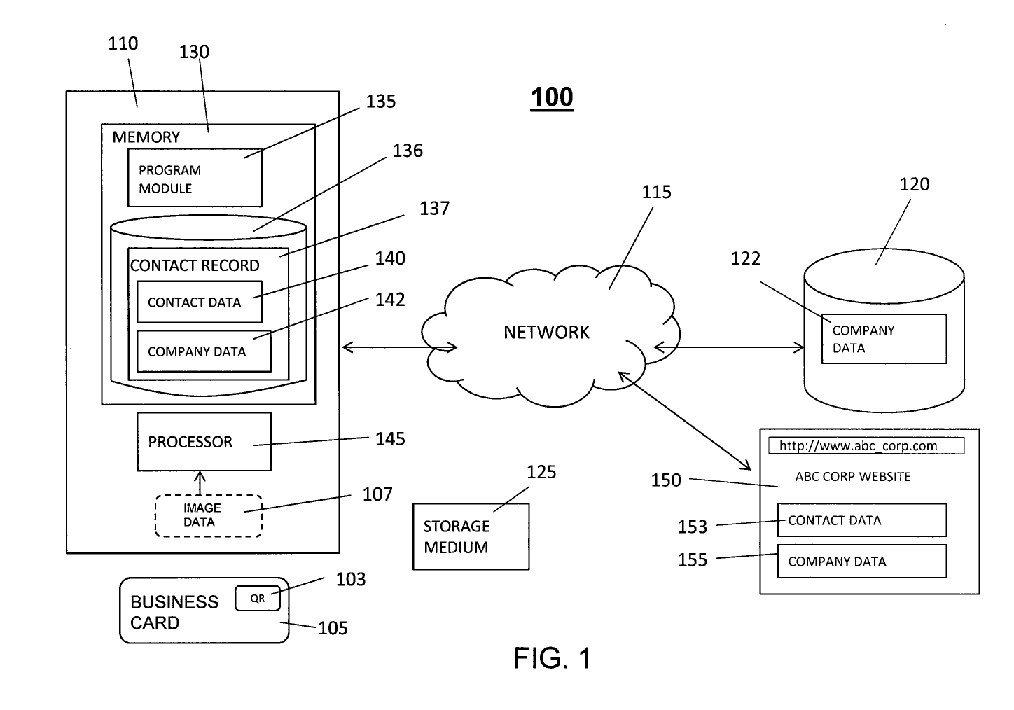

A component or a feature that is common to more than one of FIGS. 1-5 is indicated with a same reference number in each of the drawings.

### DESCRIPTION

FIG. 1 is a block diagram of a system, e.g., system 100, for electronically managing business contact information.

System 100 includes a business card 105, a device 110, a network 115, a repository 120 and a website 150.

Network 115 is a data communication network such as the Internet.

Device 110 is coupled to network 115. Device 110 includes a processor 145, and a memory 130. Device 110 is an access device capable of receiving and transmitting data. For example, device 110 may be implemented as a mobile phone, a computer terminal, a tablet, a laptop, and other computational devices.

Although device 110 is represented herein as a stand-alone device, it is not limited to such, but instead can be coupled to other devices (not shown) in a distributed processing system.

Processor 145 is an electronic device configured of logic circuitry that responds to and executes instructions.

Memory 130 is a tangible, machine-readable medium encoded with a program. In this regard, memory 130 stores data and instructions that are readable and executable by processor 145 for controlling the operation of processor 145. Memory 130 may be implemented in a random access memory (RAM), a hard drive, a read only memory (ROM), or a combination thereof. Memory 130 includes a database 136 having a contact record 137. Contact record 137 includes contact data 140 and company data 142.

Company data 142 includes data such as, but not limited to: a company's official name, a list of company names, e.g., doing-business-as, a company identifier, a company synopsis, e.g., an overview/introduction of the company, an official address of the company, a longitude/latitude position of the company address, a primary telephone number, a primary fax number, industry information, a number of employees at a company location, an annual sales number, officer names and titles within the company. For example, three officer names and titles are provided. Company data 142 further includes a data universal numbering system (DUNS) number, an expanded company synopsis, a number of employees at all company locations, employee growth, e.g., a percentage growth for all employees at all locations, revenue growth, biographical text of company officers, information relating to competitors of the company, e.g., a competitor name, a competitor's annual sales, a competitor's company locations.

Memory 130 further includes program module 135. Program module 135 contains instructions for controlling processor 145 to execute the methods described herein. The term “module” is used herein to denote a functional operation that may be embodied either as a stand-alone component or as an integrated configuration of a plurality of sub-ordinate components. Thus, program module 135 may be implemented as a single module or as a plurality of modules that operate in cooperation with one another. Moreover, although program module 135 is described herein as being installed in memory 130, and therefore being implemented in software, it could be implemented in any of hardware (e.g., electronic circuitry), firmware, software, or a combination thereof.

Under control of program module 135, processor 145 receives image data 107 from business card 105. Image data 107 is a digital image of business card 105. Processor 145 processes image data 107 to yield contact data 140 which is stored in contact record 137. Contact data 140 may include information such as an address, an email address, a phone number, a fax number, a business name, a business address, a business phone number and a business email.

Processor 145, via network 115, obtains company data 122 from repository 120 based on contact data 140. That is, processor 145, via network 115, requests matching company data via a search query that contains contact data 140. Matching means searching for a record that best matches a given inquiry. Repository 120 receives the search query and matches company data, i.e., company data 122, to contact data 140. Matching company data 122 is provided to processor 145, via network 115, and is thereafter stored as company data 142 in contact record 137. Thus, contact data 140 and matching company data 142 are linked via contact record 137.

For example, processor 145 receives image data 107 of business card 105. Processor 145 processes image data 107 to yield contact data 140. Processing may include, but is not limited to optical character recognition (hereinafter “OCR”). Contact data 140 may include a name of a person and a business name, e.g., “John Smith” and “XYZ LLC”. Processor 145 prepares a query that includes the term “John Smith and “XYZ LLC” and, via network 115, seeks to match contact data 140 with company data 122 stored in repository 120. Thereafter, processor 145 retrieves matched company data 122, via network 115, and stores it in contact record 137. Repository 120, in response to the query, may return a list of resultant companies. Accordingly, processor 145 displays the list on a display (not shown) on device 110. A user of device 110 selects a desired company from the list. After selection, the matched company data 122, associated with the desired company, is stored as company data 142 together with contact data 140 in contact record 137. Thereafter, the user may select contact record 137 from device 110. Contact record 137, including contact data 140 and matching company data 142, is presented to the user on a display (not shown).

After contact record 137 is stored in database 136, a user (not shown) can request contact record 137. Processor 145 receives the request and displays contact record 137 on a display (not shown) to the user. That is, contact data 140 and company data 142 are displayed as contact record 137 to the user. Thus, the user, accessing contact record 137 is quickly presented with a scope and breadth of information.

Typically, database 136 contains a plurality of contact records. Each of the plurality of contact records contains unique individual contact and company data previously associated with the contact data. The user requests a particular contact record or contact records via processor 145. Processor 145 returns resultant contact records according to the request, and displays the resultant contact records on a display (not shown). The user selects a desired contact record and processor 145 further displays the selected contact record, which comprises previously associated contact data and company data. For example, the user may request contact records of “John Smith” from database 136. Processor 145 receives the request, matches and displays a list of contact records containing instances of “John Smith”. The list of contact records is typically displayed according to a person's name. Alternatively, contact records may be displayed according to a business and address, or any related data contained within contact data 140 and its' associated company data 142. Thereafter, the user selects the desired instance of “John Smith” and processor 145 displays the contact record.

Image data 107 may be an image of a quick response code 103 (hereinafter “QR code”). A QR code is a specific matrix barcode or two-dimensional code. QR codes typically include black modules arranged in a square pattern on a white background. QR codes include encoded information such as contact data 140 that can include a website address, e.g., a uniform resource locator (hereinafter “URL”), to website 150.

Processor 145 processes QR code 103 to yield contact data 140.

Alternatively, processor 145 processes QR code 103 to yield an address of a website 150, i.e., ABC Corp website address “http://www.abc_corp.com”. Website 150 is hosted on a server (not shown) that is coupled to network 115. Processor 145 accesses website 150, via network 115, and obtains contact data 153. In addition, processor 145 can obtain company data 155 based on QR code 103. Alternatively, processor 145 can obtain, e.g., match contact data 140 with, company data 155. Thereafter, company data 155 is stored as matched company data 142 together with contact data 140 in contact record 137.

Company data 142, company data 122 and company data 155 typically represent the same data. For example, website 150 may access repository 120 and cache company data 122 as “local” company data 155.

Alternatively, company data 155 may be different than company data 122. That is, website 150 can provide company data 155 derived from a different repository (not shown).

In addition, company data is provided via a subscription service. That is, portions of company data are provided based on a level of subscription. An increasing level of subscription corresponds with an increasing amount of company data provided.

Processor 145 outputs, to a user interface (not shown), a result of an execution of the methods described herein. Alternatively, processor 145 could direct the output to a remote device (not shown) via network 115.

While program module 135 is indicated as already loaded into memory 130, it may be configured on a storage medium 125 for subsequent loading into memory 130. Storage medium 125 is also a tangible, machine-readable medium that stores program module 135 thereon. Examples of storage medium 125 include a floppy disk, a compact disk, a magnetic tape, a read only memory, an optical storage media, universal serial bus (USB) flash drive, a digital versatile disc, or a zip drive. Alternatively, storage medium 125 can be a random access memory, or other type of electronic storage, located on a remote storage system and coupled to device 110 via network 115.

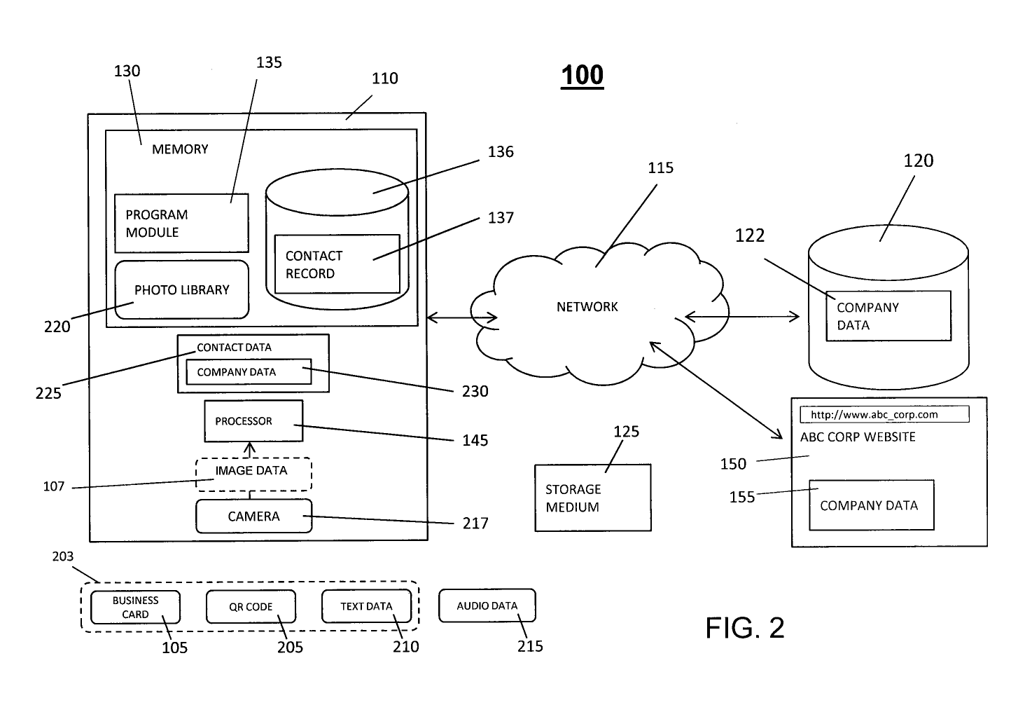

FIG. 2 is another block diagram of system 100, and includes additional features. In particular, FIG. 2 provides image sources 203 that include: business card 105, a QR code 205, and text data 210. In addition, FIG. 2 provides an audio data source, i.e., audio data 215. Device 110 further includes a camera 217 and contact data 225. Memory 130 further includes a photo library 220.

Processor 145, under the control of program module 135, receives image data 107 from camera 217. That is, camera 217 takes a picture of: business card 105, QR code 205 and/or text data 210 and provides image data 107 to processor 145. For example, device 110 can be a mobile phone having a camera 217 that images an object, thus resulting in image data 107. Image data 107 is then provided to processor 145.

Alternatively, image data 107 includes a video. That is, camera 217 takes a video of QR code 205 and provides image data 107, i.e., the video, to processor 145. Moreover, image data 107 can be provided to processor 145 via network 115. For example, processor 145 receives an email having image data, and thus, processor 145 receives image data.

Processor 145 processes image data 107 to yield contact data 225 having company data 230. For example, processor 145 performs OCR on image data 107, thus yielding contact data 225 having company data 230. Processor 145 matches contact data 225 to a contact record 137. Processor 145 updates contact record 137 to include company data 230, thus yielding an updated contact record (not shown). Processor 145 then deletes contact record 137, and stores the updated contact record in database 136. In this fashion, contact record 137 can be updated, e.g., replaced, with a contact record that includes contact data 225 and company data 230.

Company data 230 may include the same information as company data 122 and company data 155; however, company data 230 is obtained from image data 107. That is, image sources 203 provide image data 107 that includes contact data 225 having company data 230. For example, a business card may include company data such as: a name, an address, a phone number, an email address, a company website address, and a picture.

QR code 205, similar to QR code 103 of FIG. 1, is a quick response code. QR code 205 may exist in any medium capable of being imaged by camera 217. For example, QR code 205 may be present in an advertisement, printed or electronic, such as: a poster, a newspaper, a magazine, and any periodical.

Text data 210 is imaged by camera 217, thus yielding image data 107. Alternatively, text data 210 is provided via an input device (not shown) such as a keyboard, e.g., a digital representation of a keyboard, or a physical keyboard. In addition, processor 145 can receive and store text data 210 as a text memo as part of contact record 137 without further processing.

Audio data 215 is provided to processor 145 via a microphone (not shown). For example, the microphone detects audio data 215 and provides audio data 215 to processor 145. Processor 145 receives audio data 215 and performs audio speech recognition (ASR), thus yielding contact data 225. Alternatively, processor 145 may receive and store audio data 215 without further processing as part of contact record 137, e.g., as an audio note or an audio memo for contact record 137.

Photo library 220 represents storage locations in memory 130 to store images. Camera 217 may image an object, e.g., take a photo of the object, and store the photo in photo library 220. Alternatively, processor 145, via network 115, receives images from, but not limited to: emails, websites and text messages with images embedded therein. Images from photo library 220 are retrieved by processor 145 and processed to yield contact data. For example, processor 145 performs OCR on images from photo library 220, thus yielding contact data 225. In other embodiments, contact record 137 includes images from photo library 220. Alternatively, a photo (not shown) from photo library 220 may be linked to contact record 137 without further storage thereof. In this fashion, when contact record 137 is selected by a user, processor 145 displays contact record 137 including the photo.

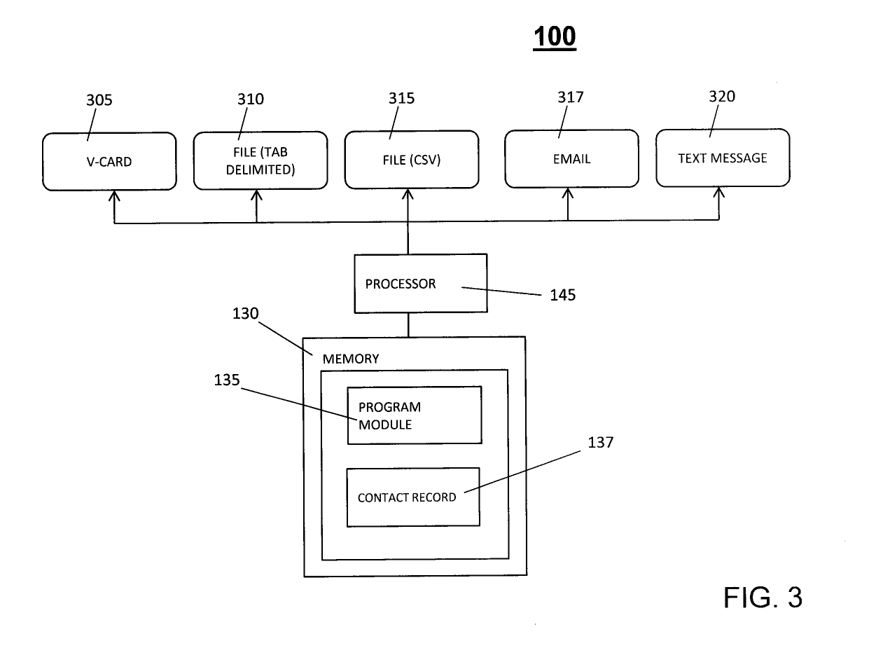

FIG. 3 illustrates additional features of system 100. In particular, FIG. 3 illustrates exporting contact record 137.

Processor 145, under the control of program module 135, receives a request for information in a contact record, e.g., contact record 137. In response to the request, processor 145 transmits the information in a format including, but not limited to: a v-card format 305, a tab delimited format 310, a comma separated value format 315, an email format 317, and a text message format 320. Text message format 320 includes a short message service format and a multimedia message service format.

Contact record 137 is transmitted by processor 145 in email format 317. That is, contact record 137 may be transmitted as text embedded in an email, as a file attached to the email, or a combination thereof.

Contact record 137 is transmitted by processor 145 in text message format 320 by creating a text message containing contact record 137 and transmitting the message. That is, processor 145 may transmit contact record 137 as follows: text data within a text message, an embedded image in the text message, or a combination thereof.

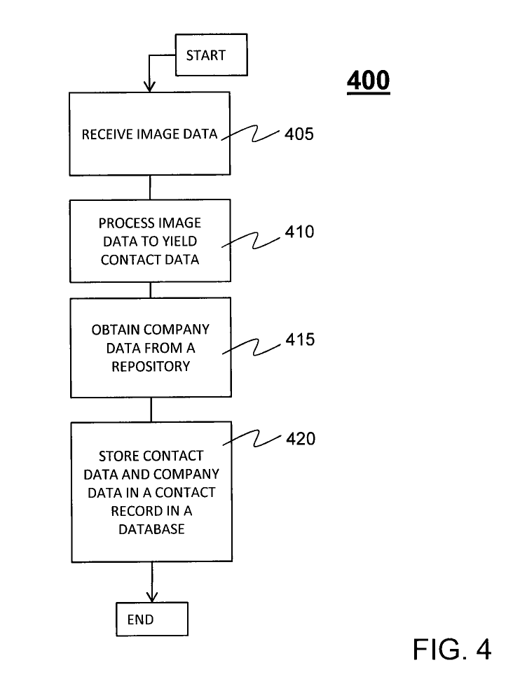

FIG. 4 is a flowchart of a method 400 of managing business contact information. Method 400 is performed by processor 145 and commences at step 405.

At step 405, processor 145 receives image data. For example, processor 145 receives image data from camera 217. From step 405, method 400 progresses to step 410.

At step 410, processor 145 processes the image data, thus yielding contact data. For example, processor 145 may perform OCR on the image data to yield the contact data. From step 410, method 400 progresses to step 415.

At step 415, processor 145 obtains company data from a repository based on the contact data. For example, processor 145, via network 115, may request and receive company data from repository 120. From step 415, method 400 progresses to step 420.

At step 420, processor 145 stores the contact data and the company data in a contact record in a database. For example, processor 145 stores contact data 140 and company data 142 as contact record 137 in database 136. From step 420, method 400 terminates.

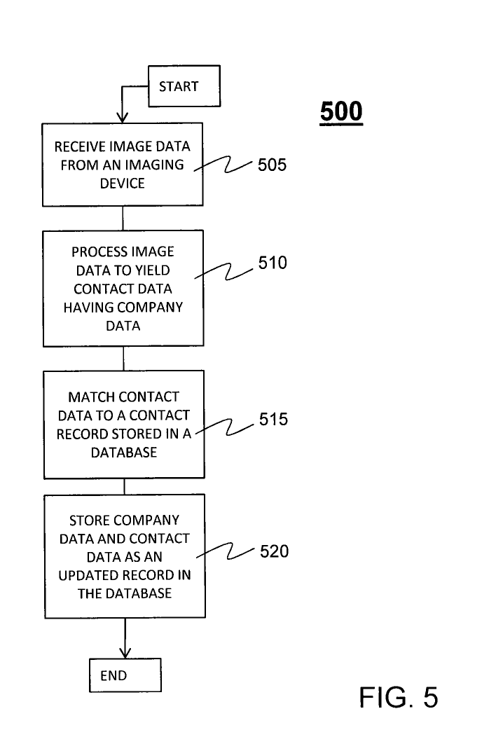

FIG. 5 is a flowchart of another method, i.e., method 500, for managing business contact information. Method 500 is performed by processor 145 and commences at step 505.

At step 505, processor 145 receives image data from an imaging device. For example, processor 145 receives image data from camera 217. From step 505, method 500 progresses to step 510.

At step 510, processor 145 processes the image data to yield contact data having company data. For example, processor 145 may perform OCR on the image data to yield contact data 225 having company data 230. From step 510, method 500 progresses to step 515.

At step 515, processor 145 matches the contact data to a contact record stored in a database. For example, processor 145 matches contact data 225 to contact record 137 stored in database 136. From step 515, method 500 progresses to step 520.

At step 520, processor 145 stores the company data and the contact data as an updated contact record in the database. From step 520, method 500 terminates.

Although system 100 is described herein as processing contact data and obtaining company data to either create or update a contact record, system 100 could be employed for any type of data. Thus, generally speaking, system 100, and more particularly processor 145 performs operations of (a) receiving image data, e.g., image data 107, (b) processing the image data to yield first data, e.g., contact data 140, (c) obtaining second data, e.g., company data 142, from a repository, e.g., repository 120, based on the first data, and (d) storing the first data and the second data as a record, e.g., contact record 140, in a database, e.g., database 136. Processor 145 also performs operations of (a) receiving image data, e.g., image data 107, (b) processing the image data to yield first data, e.g., contact data 140, and second data, e.g., company data 142, (c) matching the first data to a record, e.g., contact record 137, that is stored in a database, e.g., database 136, and (d) updating the record to include the second data.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving image data;
processing said image data to yield first data;
obtaining second data from a repository, based on said first data; and
storing said first data and said second data as a record in a database.

2. The method of claim 1, wherein said image data is a quick response (QR) code.

3. The method of claim 2,
wherein said processing comprises:
processing said QR code to yield an address of a website; and
accessing said website via a data network, and
wherein said obtaining comprises:
requesting said second data from said repository via said website; and
receiving said second data in response to said request.

4. The method of claim 1,
wherein said image data is scanned image data, and
wherein said processing comprises:
performing optical character recognition on said scanned image data, thus yielding said first data.

5. The method of claim 1,
wherein said first data is first received data, and said method further comprises:
receiving audio data; and
processing said audio data to yield second received data, and
wherein said storing further comprises:
storing said second received data in said record.

6. The method of claim 1, further comprising:
receiving a request for information;
obtaining said information from said record; and
transmitting said information in response to said request, in a format selected from the group consisting of: a v-card format, a tab delimited format, a comma separated value format, a short message service format, an email format, and a multimedia message service format.

7. The method of claim 1, wherein said first data identifies a person, and said second data describes a company with which said person is affiliated.

8. A system comprising:
a processor; and
a memory that contains instructions that are readable by said processor and cause said processor to:
receive image data;
process said image data to yield first data;
obtain second data from a repository, based on said first data; and
store said first data and said second data as a record in a database.

9. A non-transitory storage medium comprising instructions that are readable by a processor and cause said processor to:
receive image data;
process said image data to yield first data;
obtain second data from a repository, based on said first data; and
store said first data and said second data as a record in a database.

10. A method comprising:
receiving image data;
processing said image data to yield first data and second data;
matching said first data to a record that is stored in a database; and
updating said record to include said second data.

11. The method of claim 10, wherein said image data is a quick response (QR) code.

12. The method of claim 11, wherein said processing comprises:
processing said QR code to yield an address of a website;
accessing said website via a data network;
requesting said second data from a repository via said website; and
receiving said second data in response to said request.

13. The method of claim 10,
wherein said image data is scanned image data, and
wherein said processing comprises:
performing optical character recognition on said scanned image data, thus yielding said first data.

14. The method of claim 10,
wherein said first data is first received data, and said method further comprises:
receiving audio data; and
processing said audio data to yield second received data, and
wherein said updating further comprises:
storing said second received data in said record.

15. The method of claim 10, further comprising:
receiving a request for information;
obtaining said information from said record; and
transmitting said information in response to said request, in a format selected from the group consisting of: a v-card format, a tab delimited format, a comma separated value format, a short message service format, an email format, and a multimedia message service format.

16. The method of claim 10, wherein said first data identifies a person, and said second data describes a company with which said person is affiliated.

17. A system comprising:
a processor;
a database; and
a memory that contains instructions that are readable by said processor and cause said processor to:
receive image data;
process said image data to yield first data and second data;
match said first data to a record that is stored in a database; and
update said record to include said second data.

18. A non-transitory storage medium comprising instructions that are readable by a processor and cause said processor to:
receive image data;
process said image data to yield first data and second data;
match said first data to a record that is stored in a database; and
update said record to include said second data.
